(19) United States
(12) Patent Application Publication
(10) Pub. No.: US 2024/0425030 A1
(43) Pub. Date: Dec. 26, 2024

(54) INTELLIGENT OPTIMIZED ENERGY STORAGE CONTROL FOR ELECTRIFIED VEHICLES

(71) Applicant: FCA US LLC, Auburn Hills, MI (US)

(72) Inventor: Bryon E. Wasacz, South Lyon, MI (US)

(21) Appl. No.: 18/341,352

(22) Filed: Jun. 26, 2023

(51) Int. Cl. B60W 20/12; B60L 7/18; B60W 10/08; B60W 10/26; B60W 30/18; B60W 50/00

(52) U.S. Cl. CPC B60W 20/12; B60L 7/18; B60W 10/08; B60W 10/26; B60W 30/18127; B60W 50/0097; B60W 2510/244; B60Y 2200/92

(57) ABSTRACT

Intelligent optimized energy storage control techniques for an electrified vehicle include, based on a set of global positioning satellite (GPS) and map data, detecting an upcoming regeneration region that the electrified vehicle will encounter, the regeneration region being a downhill region satisfying a set of criteria, determining a potential energy of the electrified vehicle from a start to an end of the regeneration region, determining a target stored energy for an energy storage system of the electrified vehicle based on its determined potential energy, controlling an electrified powertrain of the electrified vehicle such that the energy storage system is at the target stored energy at the start of the regeneration region, and controlling a regenerative braking system of the electrified vehicle to capture kinetic energy of the electrified vehicle to fully recharge the stored energy of the energy storage system during and by the end of the regeneration region.

### FIELD

The present application generally relates to electrified vehicles and, more particularly, to techniques for intelligent optimized energy storage control for electrified vehicles.

### BACKGROUND

An electrified vehicle has an electrified powertrain including one or more battery systems that provide electrical energy (i.e., current) to one or more electric motors. For plug-in hybrid electrified vehicles (PHEVs), the battery system(s) are periodically recharged via roadside or residential charging stations. Recharging is also often performed during operation of the electrified vehicle. Regenerative braking is one primary energy capture and storage technique utilized by electrified vehicles. There are situations, however, when the electrified vehicle's battery system state of charge (SOC) is at full or near-full charge and an extended downhill region is encountered. In such situations, the conventional friction brakes would need to be applied because there is nowhere for regenerative braking energy to go (and thus is released as heat energy). This could result in excessive wear of the electrified vehicle's friction brakes. Accordingly, while such conventional energy storage control techniques do work well for their intended purpose, there exists an opportunity for improvement in the relevant art.

### SUMMARY

According to one example aspect of the invention, an intelligent optimized energy storage control system for an electrified vehicle is presented. In one exemplary implementation, the intelligent optimized energy storage control system comprises a set of sensors configured to obtain a set of global positioning satellite (GPS) and map data associated with a current trip of the electrified vehicle and a controller configured to receive, from the set of sensors, the set of GPS and map data and, based on the set of GPS and map data, detect an upcoming regeneration region that the electrified vehicle will encounter, the regeneration region being a downhill region satisfying a set of criteria, determine a potential energy of the electrified vehicle from a start of the regeneration region to an end of the regeneration region, determine a target stored energy for an energy storage system of the electrified vehicle based on its determined potential energy, control an electrified powertrain of the electrified vehicle such that the energy storage system is at the target stored energy at the start of the regeneration region, wherein the energy storage system is configured to power one or more electric motors of the electrified powertrain, and control a regenerative braking system of the electrified vehicle to capture kinetic energy of the electrified vehicle to fully recharge the stored energy of the energy storage system during and by the end of the regeneration region.

In some implementations, the controller controls the regenerative braking system such that its maximum amount of kinetic energy is captured during the regeneration region. In some implementations, the controller is configured to control the electrified powertrain such that the energy storage system reaches the target stored energy by increasing an amount of drive torque provided by the one or more electric motors and decreasing an amount of drive torque provided by an internal combustion engine of the electrified powertrain. In some implementations, wherein the GPS and maps data includes a route that the electrified vehicle is traveling and a set of road parameters associated with each a plurality of road segments comprising the route.

In some implementations, the set of road parameters associated with each road segment of the route includes at least one of traffic signs, speed limits, traffic/congestion data, and road topography/elevation. In some implementations, the energy storage system is a battery system and the target stored energy is a target state of charge (SOC) of the battery system, and wherein the controller is configured to control the electrified powertrain such that the battery system reaches the target SOC by instructing, via a driver interface of the electrified vehicle, a driver of the electrified vehicle to temporarily stop at a roadside charging station along or nearby the route, and offloading, via the roadside charging station, a desired amount of electrical energy from the battery system back to a power grid in exchange for future charging credits.

In some implementations, the controller is configured to utilize the regenerative braking system during an entirety of the regeneration region and not utilize conventional friction brakes of the electrified vehicle during the regeneration region. In some implementations, the electrified vehicle is an extended range electrified vehicle (EREV). In some implementations, the EREV is a pickup truck.

According to another example aspect of the invention, an intelligent optimized energy storage control method for an electrified vehicle is presented. In one exemplary implementation, the method comprises receiving, by a controller and from a set of sensors, a set of GPS and map data associated with a current trip of the electrified vehicle and, based on the set of GPS and map data, detecting, by the controller, an upcoming regeneration region that the electrified vehicle will encounter, the regeneration region being a downhill region satisfying a set of criteria, determining, by the controller, a potential energy of the electrified vehicle from a start of the regeneration region to an end of the regeneration region, determining, by the controller, a target stored energy for an energy storage system of the electrified vehicle based on its determined potential energy, controlling, by the controller, an electrified powertrain of the electrified vehicle such that the energy storage system is at the target stored energy at the start of the regeneration region, wherein the energy storage system is configured to power one or more electric motors of the electrified powertrain, and controlling, by the controller, a regenerative braking system of the electrified vehicle to capture kinetic energy of the electrified vehicle to fully recharge the stored energy of the energy storage system during and by the end of the regeneration region.

In some implementations, controlling the regenerative braking system is performed such that its maximum amount of kinetic energy is captured during the regeneration region. In some implementations, controlling the electrified powertrain such that the energy storage system reaches the target stored energy incudes increasing an amount of drive torque provided by the one or more electric motors and decreasing an amount of drive torque provided by an internal combustion engine of the electrified powertrain. In some implementations, the GPS and maps data includes a route that the electrified vehicle is traveling and a set of road parameters associated with each a plurality of road segments comprising the route.

In some implementations, the set of road parameters associated with each road segment of the route includes at least one of traffic signs, speed limits, traffic/congestion data, and road topography/elevation. In some implementations, the energy storage system is a battery system and the target stored energy is a target SOC of the battery system, and wherein controlling the electrified powertrain such that the battery system reaches the target SOC includes instructing, by the controller via a driver interface of the electrified vehicle, a driver of the electrified vehicle to temporarily stop at a roadside charging station along or nearby the route, and offloading, via the roadside charging station, a desired amount of electrical energy from the battery system back to a power grid in exchange for future charging credits.

In some implementations, controlling the regenerative braking system during the regeneration region further includes utilizing the regenerative braking system during an entirety of the regeneration region and not utilizing conventional friction brakes of the electrified vehicle during the regeneration region. In some implementations, the electrified vehicle is an EREV. In some implementations, the EREV is a pickup truck.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example intelligent optimized energy storage control system according to the principles of the present application; and

FIG. 2 is a flow diagram of an example intelligent optimized energy storage control method for an electrified vehicle according to the principles of the present application.

### DESCRIPTION

As previously discussed, when an electrified vehicle's battery system state of charge (SOC) is full or near full when an extended downhill region is encountered, regenerative braking cannot occur because there is nowhere for the captured electrical energy to be stored. In other words, while thermal energy can be stored or generated (by combustion or electrical generation), the thermal energy cannot effectively be converted to other energy sources such as into electricity using thermo-electric devices other than regenerative braking. Thus, the thermal energy generated by the electrified vehicle's conventional friction brakes by braking during the downhill region would be lost to the environment, which also increases the wear of the friction brakes and potentially reduces their useful life. One possible solution is to intentionally deplete the battery system SOC immediately before the downhill region is encountered. This is also known as “e-burn,” but this is less than optimal because a potentially substantial amount of electrical energy is intentionally wasted (e.g., ˜8 kilowatts or, for heavy duty pickup truck applications, up to ˜60 kilowatts). Other drawbacks of the conventional solutions include utilizing these components (friction brakes, electric motors, etc.) in ways which they were not intended or designed for, as well as potentially requiring/adding new components such as resistor banks for thermal energy dissipation, which need to be packaged and wiring harness routed to control them thereby increasing weight/packaging and costs.

Accordingly, the present application is directed to techniques that intelligently determine how best to deplete an energy storage system (e.g., a high voltage battery system) in advance of a regeneration region (e.g., an extended downhill region satisfying a set of criteria) being encountered by the electrified vehicle. These techniques account for both the electrified vehicle's kinetic and potential energy. More specifically, these techniques predict the electrified vehicle's potential energy and proactively control the electrified vehicle such that the battery system SOC is at a target SOC when the regeneration region is encountered. These techniques are predictive in the sense that they attempt to predict operation of the electrified vehicle 100 as far in advance as possibly known (prior to the regeneration event) such that intentional waste of fuel/electricity does not occur. Thus, no immediate intentional e-burn is required, which saves the driver recharging costs and avoids the need for expensive heat-based components (e.g., resistor banks) for handling excess thermal waste heat. In one exemplary implementation, the driver could be given the opportunity to offload charge back to the power grid in exchange for future credits. These techniques leverage global positioning satellite (GPS) system and maps data to intelligently and proactively control the battery system SOC in anticipation of such regeneration regions, potentially reducing vehicle costs for the reasons described above with respect to the existing/conventional solutions.

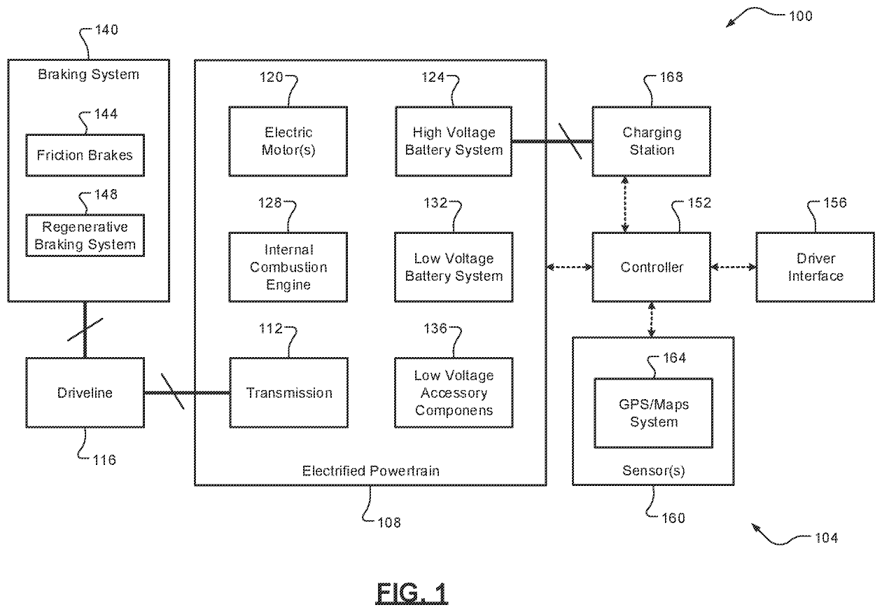

Referring now to FIG. 1, a functional block diagram of an electrified vehicle 100 having an example intelligent optimized energy storage control system 104 according to the principles of the present application is illustrated. In one exemplary implementation, the electrified vehicle 100 is an extended range electrified vehicle (EREV), such as a light duty or heavy duty EREV pickup truck (e.g., capable of towing a substantial payload). These techniques could be particularly applicable to EREVs because they often traverse longer distances per full charge and, in the case of an EREV pickup truck, they could be hauling heavy payloads or towing up/down extended grades. That said, the electrified vehicle 100 could be any suitable electrified vehicle (plug-in hybrid electric vehicle (PHEV), battery electric vehicle (BEV), etc.) and recharging of the electrified vehicle 100 via electrified vehicle supply equipment (EVSE) including a separate residential or roadside charging station 156 will be described more fully below. The electrified vehicle 100 is powered by an electrified powertrain 108 that generates and transfers drive torque (e.g., via a transmission 112, such as a multi-speed automatic transmission) to a driveline 116.

The electrified powertrain 108 includes one or more electric motors 120 powered by a high voltage battery system 124 and an optional internal combustion engine 128 configured to combust a mixture of air and fuel (diesel, gasoline, etc.). In other words, as the one or more electric motors 120 are operated to generate drive torque (torque consumer mode), the SOC of the high voltage battery system 124 is depleted. The electrified powertrain 108 also includes a low voltage battery system 132 (e.g., a 12 volt lead-acid or lithium-ion battery system) configured to power low voltage accessory loads 136 of the electrified vehicle 100 (pumps, fans, displays, etc.). The electrified powertrain 108 also includes a braking system 140 comprising a conventional friction braking system 144 and regenerative braking system 148. The regenerative braking system 148 is configured to brake (decelerate) the driveline 116 and convert the kinetic energy to electrical energy, such as for recharging the high voltage battery system 124. A direct current (DC) to DC converter (not shown) or other suitable system could be implemented between the high and low voltage battery systems 124, 132 for stepping up/down respective DC voltages (e.g., for recharging therebetween).

While a battery-equipped electrified vehicle 100 is shown and generally described herein, it will be appreciated that the techniques of the present application are not limited to battery systems and are applicable to any suitable energy storage system. Thus, the term “energy storage system” as used herein could also be applicable to, for example, fuel cell electrified vehicles (FCEVs), which have hydrogen (H2) as stored energy. A FCEV, however, is a range extender system, as the disclosed electrified vehicle 100 may be as well (i.e., an REEV), which has a gasoline-powered generator (e.g., an internal combustion engine) converting liquid gasoline (or diesel) to electricity while the FCEV has a fuel cell system converting H2 to electricity. The proposed techniques provide optimized control for a vehicle's total energy storage system comprising any of of chemical, electrical, pneumatic, thermal, kinetic, and potential energy—where some could be unidirectional (e.g., gasoline or diesel) and some could be bi-directional (electrical, pneumatic, etc.). The “target SOC” for the “battery system” as discussed herein throughout could therefore also refer to a “target capacity” or “target stored energy” of the “energy storage system.”

A controller 152 controls operation of the electrified vehicle 100, including controlling the electrified powertrain 108 to satisfy a torque request (e.g., via a driver interface 156, such as an accelerator pedal). It will be appreciated that the torque request may not come directly from the driver, but instead could be a torque request generated by an advanced driver assistance (ADAS) or autonomous driving system. The controller 152 is also configured to receive information from a set of sensors 160 to control operation of the electrified vehicle 100. Non-limiting examples of the set of sensors 160 include vehicle speed/altitude sensors, electrified powertrain speed/temperature/electrical parameter/SOC sensors, and a GPS/maps system 164, which is described in greater detail below. As previously mentioned, in some implementations, the electrified vehicle 100 is configured to interface with the roadside or residential charging station 168, which is configured to provide electrical current to the electrified vehicle 100 for recharging the high voltage battery system 124 (e.g., in exchange for monetary payment or previously-obtained credits) and, in some cases, to offload electrical current from the high voltage battery system 124 back to a power grid the charging station 168 is connected to (e.g., in exchange for monetary compensation or future-redeemable credits). In some cases, for example, the driver could have recently paid to recharge the high voltage battery system 164 via the roadside charging station 168 (e.g., shortly before encountering the downhill region), and thus this money spent would effectively be wasted if not for the techniques of the present application.

The GPS/maps system 164 could include a global navigation satellite system (GNSS) transceiver (not shown) configured to determine a precise geo-location of the electrified vehicle 100. The GPS/maps system 164 could also be configured to determine and localize the position of the electrified vehicle 100 relative to a map, such as a high-definition (HD) map. Map data could be stored remotely (e.g., at a remote server), locally (e.g., at the controller 152), or some combination thereof. The map data includes, among other things, a plurality of road segments each having varying road attributes (length, speed limit, curvature, elevation, etc.). Locations of charging stations such as charging station 168 could also be specified. A route for the electrified vehicle 100 could include a plurality of these road segments from a start point to a desired end point. In some implementations, the electrified vehicle 100 is configured to perform eco-routing, which refers to a process of minimizing battery system SOC consumption based on road attributes associated with the various road segments. For example, during eco-routing, stop signs and congested traffic regions could be avoided. The controller 152 is also configured to perform at least a portion of these intelligent (predictive) and proactive control techniques of the present application, which will now be described in greater detail with reference to a method flowchart.

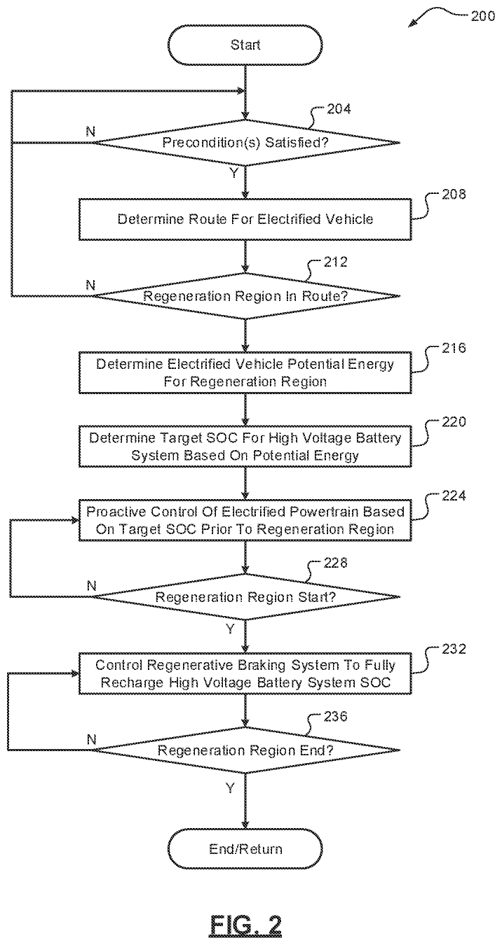

Referring now to FIG. 2 and with continued reference to FIG. 1, a flow diagram of an example intelligent optimized energy storage control method 200 for an electrified vehicle according to the principles of the present application is illustrated. While the electrified vehicle 100 and its components are specifically referenced for illustrative/descriptive purposes, it will be appreciated that the method 200 could be applicable to any suitably configured electrified vehicle. At 204, the controller 152 determines whether an optional set of one or more preconditions are satisfied. This could include, for example only, the electrified vehicle 100 being powered up and running, sufficient communication/connectivity by the GPS/maps system 164, and/or there being no malfunctions or faults present that would otherwise affect the operation of the method 200 and the electrified vehicle 100. When false, the method 200 ends or returns to 204. When true, the method 200 continues to 208. At 208, the controller 152 determines a route for the electrified vehicle 100. This route could be provided by the driver or could be based on prediction by the controller 152 (e.g., a most-likely route based on past driving behavior among other things). At 212, the controller 152 detects whether there is an upcoming (future) regeneration region in the route. When false, the method 200 ends or returns to 204.

When there is an upcoming regeneration region, the method 200 continues to 216. The term “regeneration region” as used herein (previously and here forth) refers to a downhill grade or region satisfying a set of criteria that the electrified vehicle 100 will encounter and traverse in the future (along its current route). This set of criteria could include, for example, the downhill region being at least a threshold length (e.g., a kilometer or number of kilometers) and having at least a threshold downgrade (e.g., 15% downgrade). It will be appreciated that these are merely example thresholds/percentages for descriptive purposes and that these criteria are definable and calibratable such that the techniques of the present disclosure do not activate to proactively deplete the battery system's SOC in advance of very short/minimal downhill regions that would not have a significant impact (via recaptured SOC by the regenerative braking system 148). At 216, the controller 152 determines a potential energy of the electrified vehicle 100 from a start of the regeneration region to an end of the regeneration region. This potential energy represents how much energy (electrical current) is capturable by the regenerative braking system 148 during the upcoming regeneration region, given current operating conditions (vehicle speed, temperature, etc.).

At 220, the controller 152 determines a target SOC for the high voltage battery system 124 based on the electrified vehicle's determined potential energy associated with the upcoming regeneration region. At 224, the controller 152 proactively controls the electrified powertrain 108 such that the SOC of the high voltage battery system 124 is at the target SOC at the start of the regeneration region as detected at 228. At 232, the controller 152 controls the regenerative braking system 148 to convert kinetic energy of the electrified vehicle to electrical energy to fully recharge the high voltage battery system 124 during and by the end of the regeneration region such that it reaches its maximum desired SOC (e.g., 100% or slightly less than 100%). This could include, for example, not disabling the regenerative braking system 148 until the end of the regeneration region such that no energy is wasted. At 236, the controller 152 determines whether the electrified vehicle 100 has traversed the regeneration region. When false, the method 200 returns to 232 and continues. When true, control returns to normal and the method 200 ends or returns to 204 and the process could continue for other potential regeneration regions along the route. For multiple regeneration regions, however, the proactive control of the electrified powertrain 108 could be performed for the entire vehicle trip (e.g., the entire expected route) such that the SOC of the high voltage battery system 124 may not reach maximum (e.g., 100% SOC) after an initial or intermediate regeneration region but will do so after a final regeneration region of the current vehicle route/trip.

While the proactive control (step 224) of the electrified powertrain 108 will primarily involve utilizing the electric motor(s) 120 more often for torque generation and vehicle propulsion rather than the engine 124 (and its associated consumption of fuel, such as diesel or gasoline), there could be other aspects of the proactive control of the electrified powertrain 108 such that the SOC of the high voltage battery system 128 is depleted in a non-wasteful manner. For example only, in some instances, this proactive control of the electrified powertrain 108 could additionally or alternatively include a power off-loading operation. In such instances, the controller 152 could instruct the driver (e.g., via the driver interface 156) to temporarily stop at a nearby roadside charging station 168 along or in close proximity to the route. During this temporary stop, a desired amount of electrical energy could be offloaded from the high voltage battery system 124 back to a power grid via the roadside charging station 168 in exchange for future charging credits. In some instances, the routing of the electrified vehicle 100 could also be slightly modified as part of the proactive control of the electrified powertrain 108. As mentioned above, this could include a temporary (potentially slightly off-course) stop at the roadside charging station 168 for a power off-loading operation. Also as previously discussed, whether or not the electrified vehicle 100 is currently performing eco-routing could also be taken into account. For example, eco-routing could be disabled provided that the best (e.g., shortest) route for the electrified vehicle 100 is still being followed.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An intelligent optimized energy storage control system for an electrified vehicle, the intelligent optimized energy storage control system comprising:
a set of sensors configured to obtain a set of global positioning satellite (GPS) and map data associated with a current trip of the electrified vehicle; and
a controller configured to receive, from the set of sensors, the set of GPS and map data and, based on the set of GPS and map data:
detect an upcoming regeneration region that the electrified vehicle will encounter, the regeneration region being a downhill region satisfying a set of criteria;
determine a potential energy of the electrified vehicle from a start of the regeneration region to an end of the regeneration region;
determine a target stored energy for an energy storage system of the electrified vehicle based on its determined potential energy;
control an electrified powertrain of the electrified vehicle such that the energy storage system is at the target stored energy at the start of the regeneration region, wherein the energy storage system is configured to power one or more electric motors of the electrified powertrain; and
control a regenerative braking system of the electrified vehicle to capture kinetic energy of the electrified vehicle to fully recharge the stored energy of the energy storage system during and by the end of the regeneration region.

2. The intelligent optimized energy storage control system of claim 1, wherein the controller controls the regenerative braking system such that its maximum amount of kinetic energy is captured during the regeneration region.

3. The intelligent optimized energy storage control system of claim 1, wherein the controller is configured to control the electrified powertrain such that the energy storage system reaches the target stored energy by increasing an amount of drive torque provided by the one or more electric motors and decreasing an amount of drive torque provided by an internal combustion engine of the electrified powertrain.

4. The intelligent optimized energy storage system of claim 1, wherein the GPS and maps data includes a route that the electrified vehicle is traveling and a set of road parameters associated with each a plurality of road segments comprising the route.

5. The intelligent optimized energy storage system of claim 4, wherein the set of road parameters associated with each road segment of the route includes at least one of traffic signs, speed limits, traffic/congestion data, and road topography/elevation.

6. The intelligent optimized energy storage control system of claim 4, wherein the energy storage system is a battery system and the target stored energy is a target state of charge (SOC) of the battery system, and wherein the controller is configured to control the electrified powertrain such that the battery system reaches the target SOC by:
instructing, via a driver interface of the electrified vehicle, a driver of the electrified vehicle to temporarily stop at a roadside charging station along or nearby the route; and
offloading, via the roadside charging station, a desired amount of electrical energy from the battery system back to a power grid in exchange for future charging credits.

7. The intelligent optimized energy storage system of claim 1, wherein the controller is configured to utilize the regenerative braking system during an entirety of the regeneration region and not utilize conventional friction brakes of the electrified vehicle during the regeneration region.

8. The intelligent optimized energy storage system of claim 1, wherein the electrified vehicle is an extended range electrified vehicle (EREV).

9. The intelligent optimized energy storage system of claim 8, wherein the EREV is a pickup truck.

10. An intelligent optimized energy storage control method for an electrified vehicle, the method comprising:
receiving, by a controller and from a set of sensors, a set of global positioning satellite (GPS) and map data associated with a current trip of the electrified vehicle; and
based on the set of GPS and map data:
detecting, by the controller, an upcoming regeneration region that the electrified vehicle will encounter, the regeneration region being a downhill region satisfying a set of criteria;
determining, by the controller, a potential energy of the electrified vehicle from a start of the regeneration region to an end of the regeneration region;
determining, by the controller, a target stored energy for an energy storage system of the electrified vehicle based on its determined potential energy;
controlling, by the controller, an electrified powertrain of the electrified vehicle such that the energy storage system is at the target stored energy at the start of the regeneration region, wherein the energy storage system is configured to power one or more electric motors of the electrified powertrain; and
controlling, by the controller, a regenerative braking system of the electrified vehicle to capture kinetic energy of the electrified vehicle to fully recharge the stored energy of the energy storage system during and by the end of the regeneration region.

11. The method of claim 10, wherein controlling the regenerative braking system is performed such that its maximum amount of kinetic energy is captured during the regeneration region.

12. The method of claim 10, wherein controlling the electrified powertrain such that the energy storage system reaches the target stored energy incudes increasing an amount of drive torque provided by the one or more electric motors and decreasing an amount of drive torque provided by an internal combustion engine of the electrified powertrain.

13. The method of claim 10, wherein the GPS and maps data includes a route that the electrified vehicle is traveling and a set of road parameters associated with each a plurality of road segments comprising the route.

14. The method of claim 13, wherein the set of road parameters associated with each road segment of the route includes at least one of traffic signs, speed limits, traffic/congestion data, and road topography/elevation.

15. The method of claim 13, wherein the energy storage system is a battery system and the target stored energy is a target state of charge (SOC) of the battery system, and wherein controlling the electrified powertrain such that the battery system reaches the target SOC includes:
instructing, by the controller via a driver interface of the electrified vehicle, a driver of the electrified vehicle to temporarily stop at a roadside charging station along or nearby the route; and
offloading, via the roadside charging station, a desired amount of electrical energy from the battery system back to a power grid in exchange for future charging credits.

16. The method of claim 10, wherein controlling the regenerative braking system during the regeneration region further includes utilizing the regenerative braking system during an entirety of the regeneration region and not utilizing conventional friction brakes of the electrified vehicle during the regeneration region.

17. The method of claim 10, wherein the electrified vehicle is an extended range electrified vehicle (EREV).

18. The method of claim 17, wherein the EREV is a pickup truck.
